(19) United States
(12) Patent Application Publication
(10) Pub. No.: US 2019/0181414 A1
(43) Pub. Date: Jun. 13, 2019

(54) BATTERY

(71) Applicant: NEC ENERGY DEVICES, LTD., Sagamihara-shi, Kanagawa (JP)

(72) Inventor: Kento TAKAHASHI, Kanagawa (JP)

(73) Assignee: NEC ENERGY DEVICES, LTD., Sagamihara-shi, Kanagawa (JP)

(21) Appl. No.: 16/307,780

(22) PCT Filed: Apr. 25, 2017
(86) PCT No.: PCT/JP2017/016273

§ 371 Date: Dec. 6, 2018

(30) Foreign Application Priority Data
Jul. 1, 2016 (JP) 2016-131240

(51) Int. Cl. H01M 2/18; H01M 2/14

(52) U.S. Cl. CPC H01M 2/18; H01M 2/145

(57) ABSTRACT

This battery is provided with: an electrode assembly (20) resulting from stacking a positive electrode, a negative electrode, and a separator arranged between the positive electrode and the negative electrode, and an external sheathing film (12) composed of a pair of resin layers, of which outer peripheries are heat-welded together, and that sandwich the electrode assembly (20). At least one of the electrode assembly has a protruding part (24) that protrudes from the electrodes, and is interposed at a peripheral area by the welded portion of the external sheathing film (12), and that restrains movement of the separators.

### TECHNICAL FIELD

The present invention relates to a laminated battery that has an electrode assembly resulting from stacking a positive electrode, a negative electrode, and a separator arranged between the positive electrode and the negative electrode and an external sheathing film that accommodates the electrode assembly.

### BACKGROUND ART

In recent years, batteries used for electric power storage and for electric power-assisted bicycles or automobiles have increasingly required lighter weight and larger capacity. As a result, flat batteries have come to be adopted for these usages in which battery elements such as electrode assembly and electrolyte are enclosed using an external sheathing film. The electrode assembly include positive electrodes coated with a positive electrode active material layer, negative coated with a negative electrode active material layer, and separators. Laminated type and wound type can be offered as examples of the electrode assembly. Laminated type electrode assembly is composed of positive electrodes and negative electrodes that are repeatedly and alternately stacked. The separators are arranged between the positive electrodes and the negative electrodes and electrically isolate the negative electrodes and positive electrodes. Wound-type electrode assembly is composed by winding positive electrodes and negative electrodes that are electrically isolated using separators. In a laminated-type electrode assembly, the electrode can be arranged more densely inside the external sheathing film than in a wound-type electrode assembly, and as a result, offers the advantage of greater capacity per unit volume. One end of each lead that is an external terminal of the battery is connected to the electrode assembly. The other end of the lead is to be connected to an external device or circuit and therefore is drawn out to the exterior of the external sheathing film. A material such as a thermoplastic resin is provided on the external sheathing film and the portion of the lead that contacts the external sheathing film, and the peripheries of the external sheathing films and the contact portion of the external sheathing film and the leads are heat-welded to enclose the electrode assembly inside the external sheathing film with liquid tightness. The electrode assembly is substantially secured inside the external sheathing film by, for example, the resin that is provided on the external sheathing film and the leads.

Nevertheless, a great deal of stress is applied to the leads when the electrode assembly is subjected to vibration from the outside. The application of a great deal of stress to the leads raises the concern that the leads will be damaged or broken. Increasing the thickness of the leads can be considered as a means of preventing this damage to the leads. However, increasing the thickness of the leads also leads to such problems as a reduction of the ability of sealing (liquid tightness) of the external sheathing film and an increase in production cost and weight.

Accordingly, some designs have been disclosed for preventing damage to the leads. For example, Patent Document 1 discloses a battery in which, of the peripheral surfaces of a separator, the two sides other than the sides on which electrode leads are attached are secured together with sealing parts of the battery case as surplus portions. In addition, Patent Document 2 discloses a battery in which through-holes are provided in a portion of the outer periphery of a separator layer and laminated films are fused together by way of these through-holes.

### LITERATURE OF THE PRIOR ART

### Patent Documents

### Patent Document 1: Japanese Patent No. 4562693

### Patent Document 2: Japanese Unexamined Patent Application Publication No. 2013-084410

### SUMMARY OF THE INVENTION

### Problem to be Solved by the Invention

In the battery construction that is disclosed in Patent Document 1, when a multiplicity of separators are secured to sealing parts of the battery case, of the multiplicity of separators, the layers that contact the battery case are heat-welded to a heat-welding layer of the battery case. At this time, the separators must be heat-welded together in order to secure separators that are sandwiched between separators. In recent years, separators having a capacity to resist heat have been sought from the viewpoint of battery safety. When separators having heat resistance are consequently used, the difficulty of heat-welding these separators together becomes an issue. In addition, when there are many separators to be secured, a great deal of heat must be applied to heat-weld all separators including those that are a greater distance from the battery case, and the concern therefore arises that the battery case will suffer damage.

In the battery construction disclosed in Patent Document 2, the generation of gas from inside the battery that results from charging/discharging of the battery causes swelling, and when there are few through-holes, the stress exerted on the laminated films concentrates upon portions that have been heat-welded by way of the through-holes of the separator layers, raising the concern that the mutual fusing of the laminated films will delaminate. On the other hand, when there are many through-holes, the width of the separator layer between through-holes decreases compared to a case of few through-holes, raising the concern for damage should the battery be subjected to a shock. Still further, even if a suitable number of through-holes are arranged, the problem remains that complex manufacturing processes are required for, for example, the formation of the holes and the removal of the small fragments that have been cut away as hole portions.

It is an object of the present invention to provide a battery that solves the above-described problems.

### Means for Solving the Problem

The battery of the present invention is a battery provided with: an electrode assembly resulting from stacking a positive electrode, a negative electrode, and a separator arranged between the positive electrode and the negative electrode, and an external sheathing film that is composed of a pair of resin layers of which outer peripheries are heat-welded together, and that sandwich the electrode assembly;

wherein at least one separator of the electrode assembly has a protruding part that protrudes from the electrodes, and is interposed at a peripheral area by a welded portion of the external sheathing film, and that restrains movement of the separators.

### Effect of the Invention

The present invention as described hereinabove can both easily suppress shifting of the position of an electrode assembly due to vibration or shock and prevent electrical short-circuits between metal layers.

### BRIEF DESCRIPTION OF THE DRAWINGS

FIG. 1 is an outer schematic perspective view of an exemplary embodiment of the battery of the present invention.

FIG. 2 is a schematic plan view of an exemplary embodiment of the battery of the present invention.

FIG. 3 is a schematic cross-sectional view of an electrode assembly taken along the alternate long and short dash line of 3A-3A′ of FIG. 2.

FIG. 4A is a schematic plan view showing an example of the construction of the electrode assembly shown in FIG. 2.

FIG. 4B shows details of the construction of the separator shown in FIG. 4A.

FIG. 5 is a schematic cross-sectional view of the battery taken along the alternate long and short dash line of 5A-5A′ shown in FIG. 4A.

FIG. 6 is a schematic plan view showing the welded portion of the external sheathing films and the separator shown in Example 1.

FIG. 7A is a schematic plan view showing the welded portion of the external sheathing films and the separator in Example 2.

FIG. 7B shows details of the construction of the separator shown in FIG. 7A.

FIG. 8A is a schematic plan view showing the welded portion of the external sheathing films and the separator in Example 3.

FIG. 8B shows details of the construction of the separator shown in FIG. 8A.

FIG. 9 is a schematic plan view showing the welded portion of the external sheathing films and the separator in Comparative Example 1.

FIG. 10 is a view for describing an example of a manufacturing method of a separator having a protruding part.

FIG. 11A is a view for describing another example of a manufacturing method of a separator having a protruding part.

FIG. 11B shows a form that uses a separator that is cut out along the broken lines shown in FIG. 11A.

### BEST MODE FOR CARRYING OUT THE INVENTION

Exemplary embodiments of the present invention are next described with reference to the accompanying drawings. The present invention can be generally applied to a battery such as a lithium-ion secondary battery. In addition, the present invention is particularly effective in batteries provided with laminated electrode assembly realized by stacking electrodes and separators.

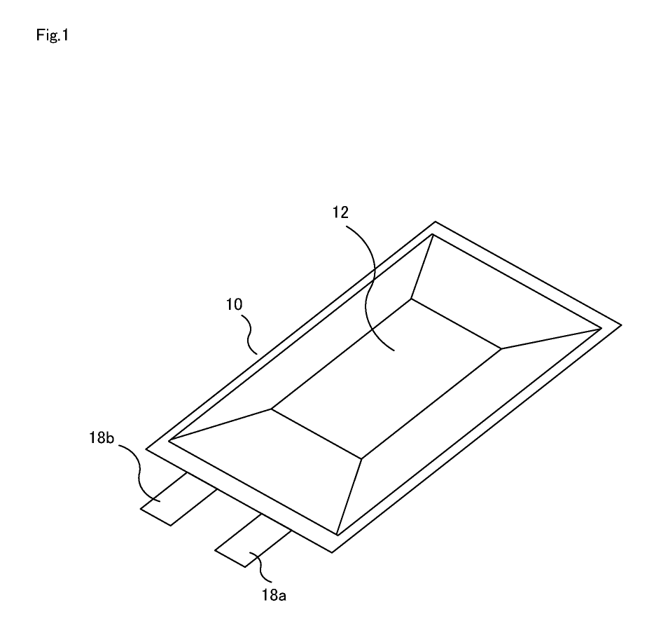

FIG. 1 is a schematic outer perspective view of an exemplary embodiment of the battery of the present invention. As shown in FIG. 1, battery 10 in the present exemplary embodiment is enclosed by external sheathing film 12 and equipped with leads 18a and 18b for connecting with an outside device or circuit.

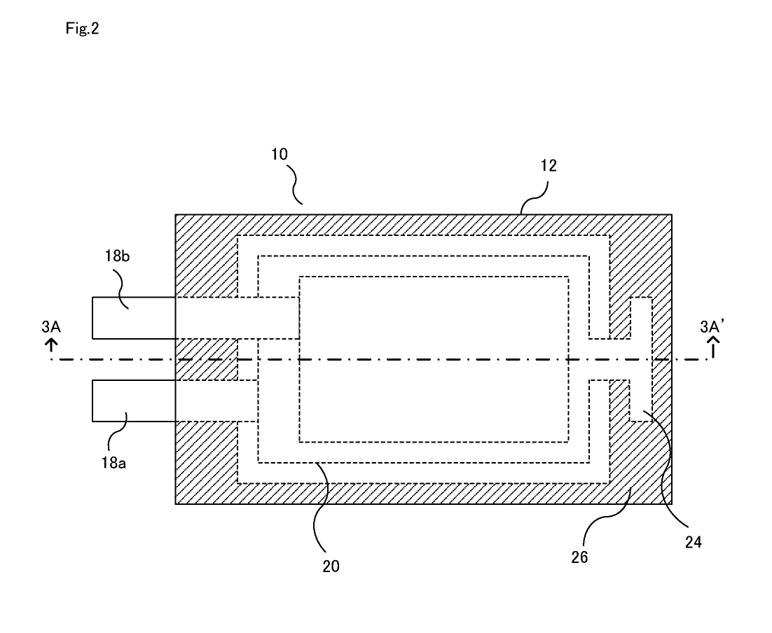

FIG. 2 is a schematic plan view of an exemplary embodiment of the battery of the present invention. As shown in FIG. 2, battery 10 in this embodiment is provided with electrode assembly 20, external sheathing film 12 that accommodates electrode assembly 20, leads 18a and 18b, protruding part 24, and welded portion 26. Leads 18a and 18b that are used as electrode terminals are connected to electrode assembly 20. Leads 18a and 18b are interposed between upper and lower thermoplastic resin and drawn out to the outside from electrode assembly 20. In FIG. 2, the portions of leads 18a and 18b and electrode assembly 20 that are covered by external sheathing film 12 are shown by broken lines.

As one example, external sheathing film 12 is made up from a pair of films in which the outer peripheries have been welded together. External sheathing film 12 is sealed with liquid tightness such that electrolyte that is sealed inside does not leak. Each of the films that make up external sheathing film 12 can employ an aluminum laminate film. One example that can be offered of an aluminum laminate film is a film of a three-layer construction composed of a resin layer of, for example, nylon or polyimide, an aluminum layer, and a thermoplastic resin layer of, for example, polypropylene. The polypropylene has thickness on the order of 30-100 μm. The thermoplastic resin layers of a pair of films are heat-welded together to form external sheathing film 12. As another example, external sheathing film 12 may be of a form in which one film having a resin layer formed on one surface is folded in two. External sheathing film 12 may be of any configuration as long as it is of a form in which the outer peripheries of resin layers that confront each other are welded together.

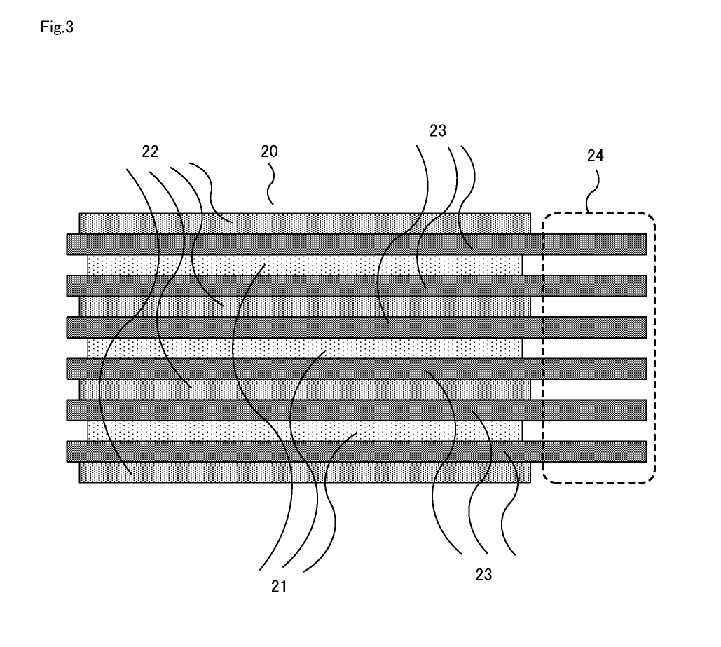

FIG. 3 is a schematic cross-sectional view of electrode assembly 20 taken along the alternate long and short dash line of 3A-3A′ of FIG. 2. Electrode assembly 20 includes positive electrodes 21, negative electrodes 22, and separators 23.

Positive electrodes 21 are formed by coating a positive electrode active material layer onto a metallic foil used as a collector. Negative electrodes 22 are formed by coating a negative electrode active material layer onto a metallic foil used as a collector. Lead 18a is connected to positive electrode sheet 21 and lead 18b is connected to negative electrode 22.

Aluminum foil can be used as the collectors that makes up positive electrodes 21. A positive electrode active material layer is coated on both surfaces of this aluminum foil. The positive electrode active material layer may contain lithium cobalt oxide, lithium nickel oxide, lithium manganese oxide, or an active material in which these compounds are combined. As necessary, the positive electrode active material layer may also be a substance containing, for example, a binder. A copper foil can be used as the collector that makes up the negative electrode 22. A negative electrode active material layer is coated on both surfaces of the copper foil. A carbon material such as carbon or graphite, a metal such as iron (Fe), silicon (Si), tin (Sn), or titanium (Ti), or a compound such as an oxide or an alloy that contains these metals that can occlude and emit lithium ions can be used as the negative electrode active material layer. The negative electrode active material layer may also be a combination of these carbon materials, metals, and compounds. The positive electrode active material layer and negative electrode active material layer may be materials that contain a conductive supplement for raising the conductivity and may also be materials that contain other additives. The positive electrode active material layer and negative electrode active material layer are not limited to these examples and may also be a combination of any materials as long as battery functions are realized.

Positive electrodes 21 and negative electrodes 22 are alternately arranged (stacked) with separators 23 interposed. Separators 23 electrically insulate positive electrodes 21 and negative electrodes 22. Separators 23 are composed of, for example, polymer sheets that hold a non-aqueous electrolyte. Separators 23 have minute voids, and the electrolyte impregnates the voids. Separators 23 can employ a single-layer polypropylene or polyethylene, or a stacked polypropylene layer and polyethylene layer. Separators 23 can employ aromatic polyamides. Separators 23 are preferably of a material having a melting point not greater than the melting point of the thermoplastic resin that makes up external sheathing film 12. Separators 23 preferably have a thickness of from 10 to 30 μm. The material of the separators is not limited to these examples and may be a combination of any materials as long as it provides insulation.

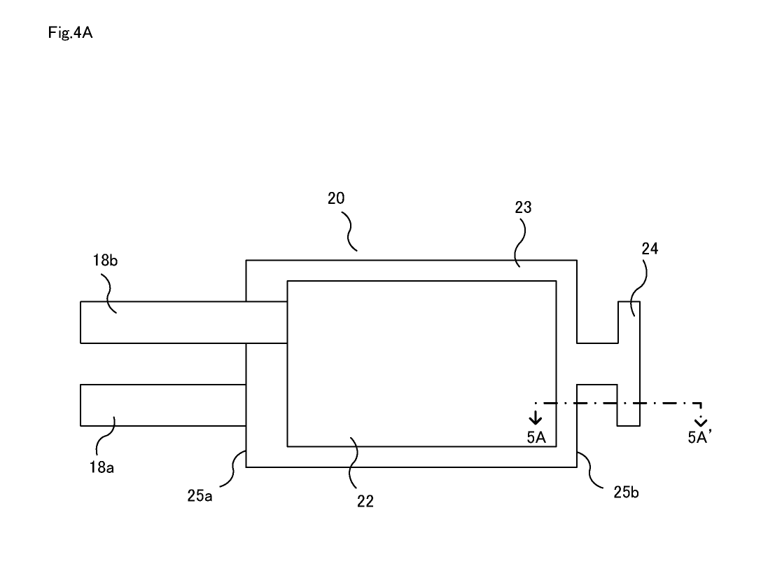

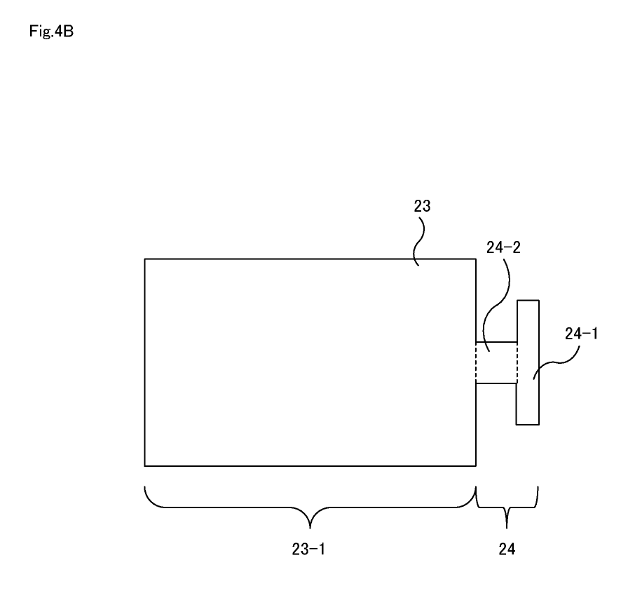

FIG. 4A is a schematic plan view showing the construction of electrode assembly 20 that is shown in FIG. 2. As shown in FIG. 4A, electrode assembly 20 has negative electrode 22 on an upper layer with separator 23 stacked below. In addition, negative electrode 22 and lead 18b are connected. Although not shown in FIG. 4A because it is stacked underneath separator 23, positive electrode 21 and lead 18a are connected. In addition, separator 23 forms protruding part 24 that protrudes from the electrodes on side 25b that is on the side opposite from side 25a on which leads 18a and 18b are connected.

FIG. 4B shows details of the construction of separator 23 that is shown in FIG. 4A.

As shown in FIG. 4B, separator 23 that is shown in FIG. 4A is made up from separator body 23-1 that is the portion of separator 23 other than protruding part 24, clamped part 24-1 that suppresses movement of separator body 23-1, and connecting part 24-2 that connects separator body 23-1 with clamped part 24-1. This suppression of the movement of separator body 23-1 will be described hereinbelow. The length of clamped part 24-1 in a direction that is substantially perpendicular to the direction of protrusion of protruding part 24 may be greater than the length of connecting part 24-2 in a direction that is substantially perpendicular to the direction of protrusion.

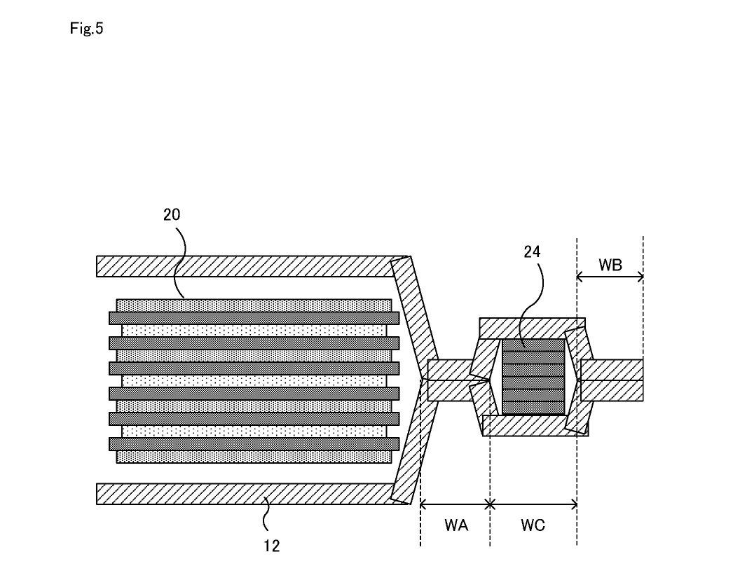

FIG. 5 is a schematic cross-sectional view of battery 10 taken along the alternate long and short dash line of 5A-5A′ shown in FIG. 4A. In the example shown in FIG. 5, all of separators 23 that make up battery 10 form protruding parts 24, but protruding parts 24 may also be formed by only a portion of separators 23 that make up battery 10. Although punching, cutting, and fusion cutting can be offered as methods of cutting separators 23 for forming these protruding parts 24, not particularly limited, and from the viewpoints of cutting speed and cutting quality, the cutting is preferably implemented by laser cutting. Protruding parts 24 are enclosed by welded portion 26 of external sheathing films 12 at the outer peripheries of external sheathing films 12. Clamped parts 24-1 that are a portion of protruding parts 24 are on the outer side of portion WA in which the resin layers of external sheathing films 12 are welded together, and moreover, are clamped by resin layers at WC that is on the inner side of portion WB in which the resin layers are similarly welded together.

From the standpoint of airtightness, the width of welded portion WB is preferably greater than or equal to 2 mm. Here, the width of WB is the length of WB in the direction of protrusion of protruding part 24. In addition, from the standpoint of shock resistance, the width of welded portion WA is preferably greater than or equal to 2 mm. Here, the width of WA is the length of WA in the direction of protrusion of protruding part 24. If the widths of welded portion WB and welded portion WA are each less than 2 mm, the concern arises of a reduction of airtightness and shock resistance in the event of subjection to a relatively large shock. In addition, regarding the side that has leads 18a and 18b, the width of welded portions 26 is preferably greater than or equal to 5 mm.

In this way, separators 23 are secured to external sheathing film 12 by means of protruding parts 24. As a result, the movement of separator bodies 23-1 is restrained by clamped parts 24-1. Clamped parts 24-1 themselves and connecting parts 24-2 are of course also restrained from moving. As a result, electrode assembly 20 does not move greatly inside external sheathing film 12 despite subjection to vibrations and shocks. This characteristic is particularly effective against movement of separator bodies 23-1 in both forward and backward direction of the protrusion of protruding parts 24. As a result, positional shifting of electrode assembly 20 is restrained and internal short circuits can be prevented. In the step of heat-welding the external sheathing films, the external sheathing film heat-welded portion that includes clamped parts 24-1 is heat welded all together, and by providing a locking part (not shown in the figures) of clamped parts 24-1 in the outer periphery of the laminate, the electrode assembly can be simply and easily secured. This locking part is one portion of the laminate and is the part by which clamped parts 24-1 are secured.

In addition, avoiding clamped parts 24-1 and heat-welding only the external sheathing film heat-welding portion can realize stronger heat-welding that increases airtightness compared to a case in which external sheathing films 12 are heat-welded including clamped parts 24-1. By subsequently heat-welding clamped parts 24-1, the electrode assembly can be more strongly secured.

In addition, protruding parts 24 may be provided on only one side of separators 23 or may be provided on four sides including the terminal side on which leads 18a and 18b are connected. In addition, the number of protruding parts 24 per side is not limited. Further, although represented as “protruding part,” shapes are also included that lack separators 23 as long as there is clamped part 24-1 on protruding part 24. The shape of protruding part 24 is not limited to the T-shape or L-shape described hereinbelow and may assume other shapes as long as it is a shape that enables restraint of the movement of separator bodies 23-1 by means of clamped parts 24-1.

Some Examples of the present invention and comparative examples and their operation are next described hereinbelow.

### Example 1

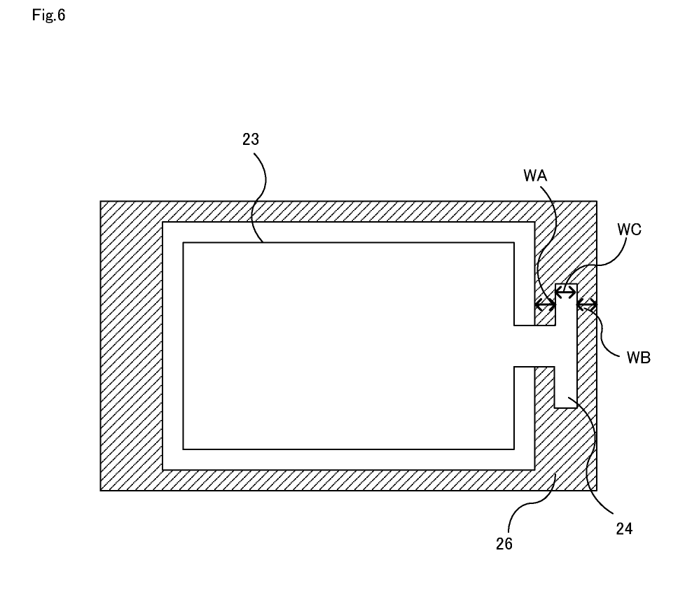

FIG. 6 is a schematic plan view showing separator 23 and welded portion 26 of the external sheathing film in Example 1.

As shown in FIG. 6, separator 23 is arranged and secured to be enclosed by welded portions 26 of external sheathing film 12. Protruding part 24 is provided only on the side that is opposite the terminal side. FIG. 6 shows only separator 23 and welded portion 26 and does not show leads, positive electrodes, negative electrodes, or the external sheathing film. In this Example 1, an electrode assembly is prepared in which eight positive electrodes and nine negative electrodes are alternately stacked on each other with separators interposed therebetween. There are sixteen separators 23. The size of external sheathing film 12 that accommodates battery 10 is 150 mm vertically and 80 mm horizontally. Identical protruding parts 24 are manufactured for all sixteen separators. Protruding parts 24 have a T shape.

### Example 2

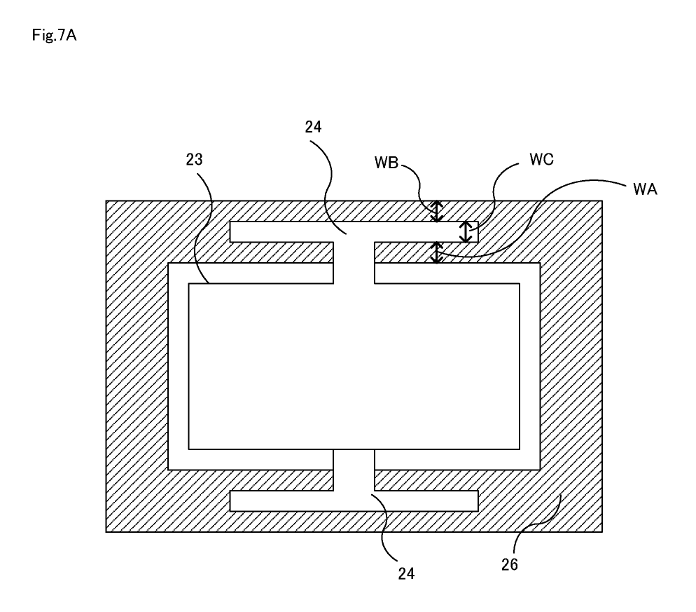

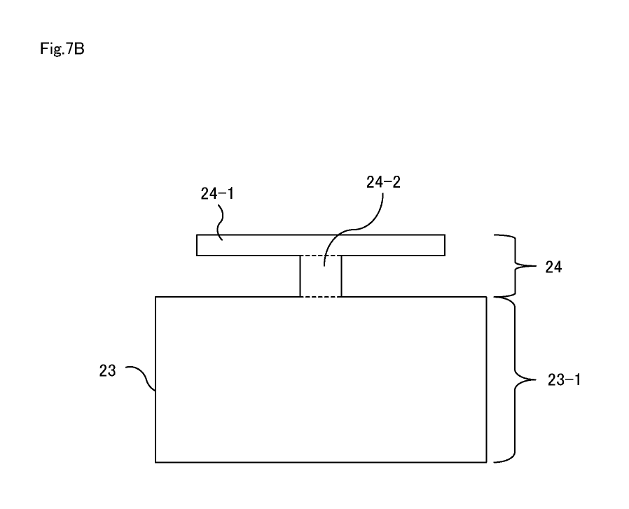

FIG. 7A is a schematic plan view showing separator 23 and welded portion 26 of the external sheathing film in Example 2.

In Example 2, as shown in FIG. 7A, protruding part 24 is provided on one site of each of the sixteen separators, these separators being stacked such that the direction of protrusion alternates between exactly opposite directions. The shape of protruding parts 24 is a T shape. Protruding parts 24 are provided on the two sides that are orthogonal to the terminal side. Further, the numbers of positive electrodes 21, negative electrodes 22 and separators 23 and the size of the battery are the same as in Example 1.

FIG. 7B shows details of the construction of separator 23 shown in FIG. 7A.

As shown in FIG. 7B, separator 23 shown in FIG. 7A is made up from separator body 23-1 that is the portion of separator 23 other than protruding part 24; and of protruding part 24, clamped part 24-1 that restrains movement of separator body 23-1 and connecting part 24-2 that connects separator body 23-1 and clamped part 24-1.

### Example 3

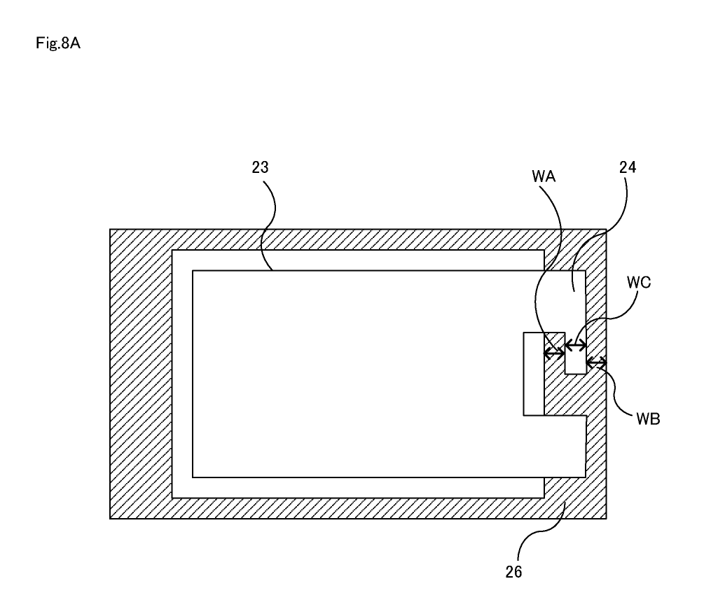

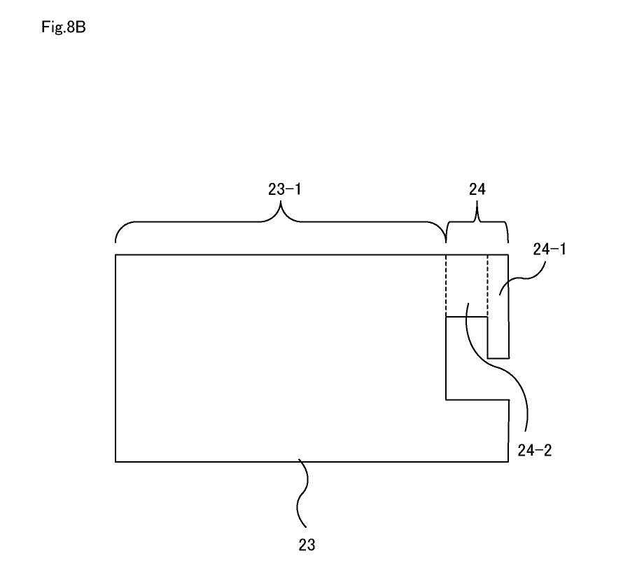

FIG. 8A is a schematic plan view showing separator 23 and welded portion 26 of the external sheathing film in Example 3.

As shown in FIG. 8A, in Example 3, a portion that has a gap toward the center is created on only one side of separator 23. The gap portion has an L shape. The same shape is produced in all of sixteen separators 23 and all are stacked in the same direction. The portion having a gap toward the center is provided on only the side that is opposite the terminal side. In addition, the numbers of positive electrodes 21, negative electrodes 22, and separators 23 and size of the battery are the same as in Example 1.

FIG. 8B shows details of the construction of separator 23 shown in FIG. 8A.

As shown in FIG. 8B, separator 23 shown in FIG. 8A is made up from separator body 23-1 that is the portion of separator 23 other than protruding part 24; and of protruding part 24, clamped part 24-1 that restrains movement of separator body 23-1 and connecting part 24-2 that connects separator body 23-1 and clamped part 24-1.

### Comparative Example 1

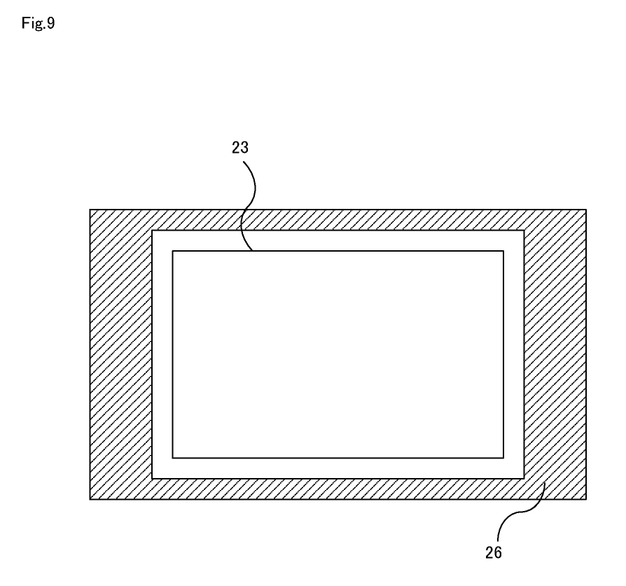

FIG. 9 is a schematic plan view showing separator 23 and welded portion 26 of the external sheathing films in Comparative Example 1.

As shown in FIG. 9, in Comparative Example 1, battery 10 was manufactured without making a protruding part such that separator 23 is not interposed in welded portion 26. Further, the numbers of positive electrodes 21, negative electrodes 22, and separators 23 and the size of the battery are the same as in Example 1.

The above-described Examples and comparative example were subjected to vibration and shock tests in the following procedures.

### Procedure 1

Each of the batteries is set to a fully charged state.

### Procedure 2

A pen is used to mark the external sheathing film at the end portion of the electrode assembly, and more specifically, at the point that corresponds to the rise portion of the embossing process.

### Procedure 3

The battery is left for at least six hours in an atmosphere in which the temperature is 20° C.±5° C. and air pressure is not greater than 11.6 kPa.

### Procedure 4

A thermal shock is applied to the battery. The battery is maintained for a minimum of six hours at a temperature of 75° C.±2° C. and then maintained for a minimum of six hours at a temperature of 40° C.±2° C. The interval of temperature change is not greater than 30 minutes. This change in temperature is repeated a total of ten times.

### Procedure 5

The battery is secured to the vibration table of vibratory equipment such that vibration is reliably conveyed to the battery. The vibration is set to a sine waveform logarithmic sweep and the vibration frequency is changed from 7 Hz to 200 Hz and then returned to 7 Hz. These conditions are maintained for 15 minutes. The battery is subjected to this vibration 12 times for each of three mutually perpendicular directions.

### Procedure 6

The battery is set to a completely discharged state.

### Procedure 7

The battery is secured in an impact device by means of a strong fixing jig and a sine half-wave shock having peak acceleration of 150 gn and a pulse duration of 6 milliseconds is applied to the battery. Shocks are applied to the battery three times for each of the positive direction and negative direction for three mutually perpendicular directions.

### Procedure 8

The amount of positional shift of the electrode assembly from the mark that was made in Procedure 2 is measured by a scale.

Table 1 is a table showing the results of the above-described tests upon the batteries of Examples 1-3 and Comparative Example 1.

TABLE 1

| | Separator protruding part | | | Number of protruding | Amount of |
|---|---|---|---|---|---|
| | Side that is | First side | Second side | parts stacked in the | positional shift |
| | opposite | orthogonal to | orthogonal to | direction of stacking in | of electrode |
| | terminal side | terminal side | terminal side | electrode assembly | assembly |
| Example 1 | ◯ | — | — | 18 | ◯ |
| Example 2 | ◯ | — | — | 3 | Δ |
| Example 3 | — | ◯ | ◯ | 9 (per side) | ◯ |
| Example 4 | ◯ | — | — | 18 | ◯ |
| Comparative | — | — | — | 0 | 4.0 mm |
| Example 1 | | | | | |

In Table 1, regarding protruding parts 24 of separators 23, “◯” is noted for sides having protruding part 24 and “-” is noted for sides that lack protruding part 24. In addition, regarding the amount of positional shift of electrode assembly of Table 1, “◯” is noted when the amount of positional shift is less than 0.5 mm, “Δ” is noted when the amount of positional shift is greater than or equal to 0.5 mm but less than 1 mm, and the numerical value is noted when the amount of positional shift is greater than or equal to 1 mm.

Based on the results shown in Table 1, the amount of positional shift of electrode assembly 20 is clearly far smaller than in Comparative Example 1 if one side or more has sites in which protruding part 24 of separator 23 is secured to external sheathing film 12. Accordingly, resistance to vibration and shocks is improved in the battery of the present Examples.

The configuration of the separators is next described.

Normally, a plurality of separators are used in a battery, and the present invention imposes no limitation regarding the number of these separators that are provided with protruding parts. The resistance to shock can be increased in proportion to the number or sites that are provided with protruding parts. On the other hand, air tightness can be increased in inverse proportion to the number of separators or sites that are provided with protruding parts. The thickness of the separators is not particularly limited for achieving both shock resistance and airtightness, but the number of separators provided with protruding parts is preferably determined such that the total thickness of the protruding parts of the separators is greater than or equal to 60 μm and less than or equal to 200 μm. When the total thickness of the protruding parts of separators is less than 60 μm, the shock resistance may be decreased in the event of subjection to greater shocks. On the other hand, when the total thickness of the protruding parts of separators surpasses 200 μm, the thickness of the heat-welded laminated portion of the periphery of the separator protruding parts increases, whereby adequate heat-welding may not be achieved and airtightness decreases.

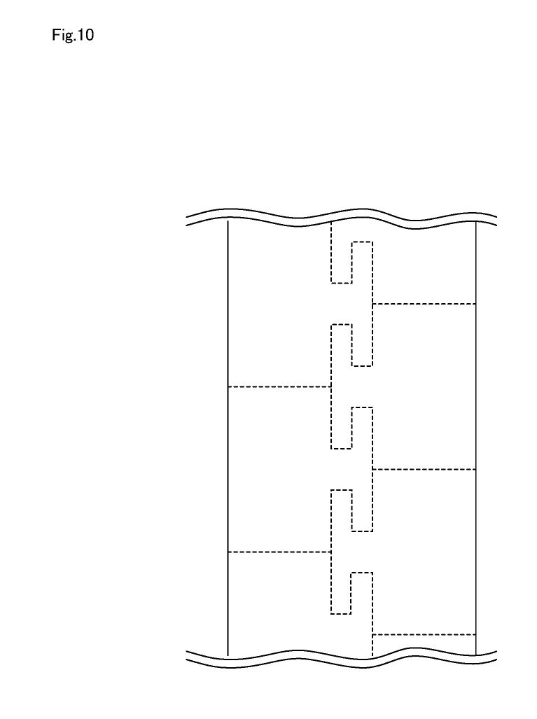

Several methods of manufacturing a separator that has a protruding part are next presented. FIG. 10 is a view for describing an example of a manufacturing method of separators that have protruding parts. FIG. 10 shows by broken lines the cutting lines when cutting out separators that are to be used in a battery from the raw material of the separators. If cutting is implemented along the broken lines shown in FIG. 10, separators can be used at a high addition rate and with virtually no waste of the separator material. In addition, although a step of producing through-holes was required in Patent Document 2 described hereinabove, the present invention obtains the effect of superior production efficiency because processing of the separators is completed simultaneously with cutting out the separators from the raw material.

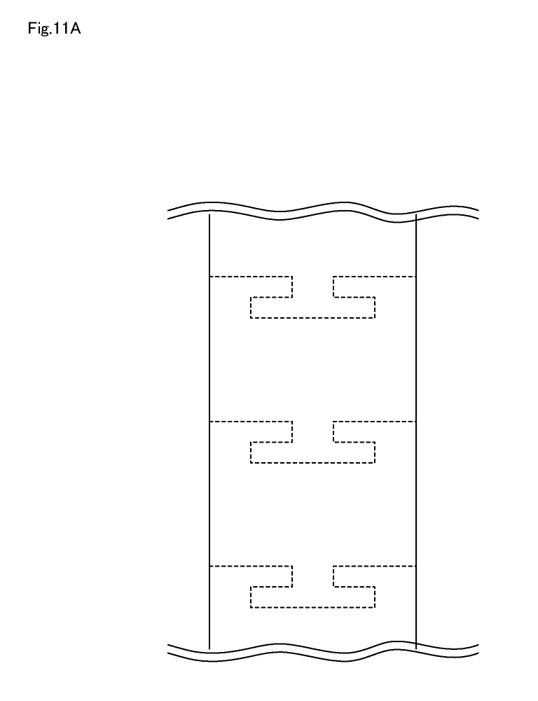

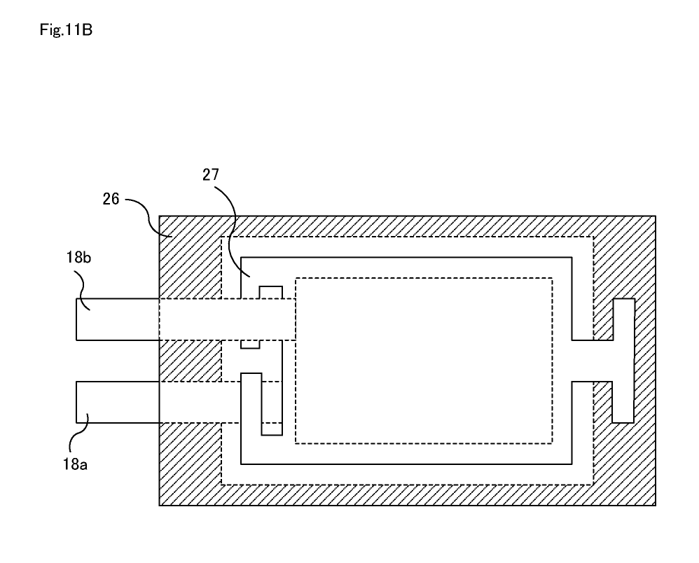

FIG. 11A is a view for describing another example of the method of manufacturing separators having protruding parts. Separators are cut out from the raw material of separators along the broken lines shown in FIG. 11A.

FIG. 11B shows one form of using separators that have been cut out along the broken lines shown in FIG. 11A. By arranging surplus 27 realized at the time of forming protruding parts more toward the inside than welded portion 26 as shown in FIG. 11B, shock resistance is increased. In particular, adopting an overlapping configuration of leads 18a, 18b and surplus 27 generated when the protruding parts are formed can prevent bending of leads 18a and 18b, whereby a further improvement of shock resistance can be anticipated. A separator of this shape is useful for providing a battery with no waste and higher productivity.

The present invention is not particularly limited the material of the separators. However, the present invention is particularly useful, in the case of using the separator containing a material which difficult to adhere to the laminate film, such as an aromatic polyamide.

The present invention can thus enable both a suppression of positional shifting of the electrode assembly caused by vibration or shocks and prevent electrical short-circuits between metal layers by means of only structural changes and without other additives or additional steps in the assembly step. In addition, a separator can also be similarly secured even when using a separator having heat resistance.

Although preferable exemplary embodiments and Examples of the present invention have been shown and described in detail, the present invention is not limited to the above-described exemplary embodiments and Examples and is open to various modifications and amendments that do not diverge from the gist of the invention.

This application claims the benefits of priority based on Japanese Patent Application No. 2016-131240 for which application was submitted on Jul. 1, 2016 and incorporates by citation all of the disclosures of that application.

All or a portion of the above-described exemplary embodiments can be described by, but are not limited by, the following Notes.

### Note 1

In a battery comprising:

an electrode assembly resulting from stacking a positive electrode, a negative electrode, and a separator arranged between the positive electrode and the negative electrode, and
an external sheathing film that is composed of a pair of resin layers of which outer peripheries are heat-welded together and that sandwich the electrode assembly;
at least one separator of the electrode assembly has a protruding part that protrudes from the electrodes,
and is interposed at a peripheral area by a welded portion of the external sheathing film, and that restrains movement of the separators.

### Note 2

In the battery as described in NOTE 1,

the protruding part restrains movement of the separators in both forward and backward direction of the protrusion.

### Note 3

In the battery as described in NOTE 1 or 2, the protruding part has:

a clamped part that restrains movement of the separator; and
a connecting part that connects the clamped part and a main body of the separator other than the protruding part.

### Note 4

In the battery as described in NOTE 3,

the length of the clamped part in a direction that is substantially perpendicular to the direction of protrusion is longer than the length of the connecting part in a direction that is substantially perpendicular to the direction of protrusion.

### Note 5

In the battery as described in any one of NOTES 1 to 4,

the thickness of the protruding part is greater than or equal to 60 μm and less than or equal to 200 μm.

### Note 6

In the battery as described in any one of NOTES 1 to 5,

the separator is interposed by the welded portion of the external sheathing film over a width of greater than or equal to 2 mm at the peripheral area.

### Note 7

The battery as described in any one of NOTES 1 to 6

further has lead parts connected to the electrode assembly and provided for connecting to the outside; and
of the external sheathing film, the width of the portion that is heat-welded along the side having the lead parts is greater than or equal to 5 mm.

### Note 8

In the battery as described in any one of NOTES 1 to 7,

the separator is selected from a separator containing aromatic polyamide resin or a ceramic-coated separator.

1. A battery comprising:
an electrode assembly resulting from stacking a positive electrode, a negative electrode, and a separator arranged between the positive electrode and the negative electrode, and
an external sheathing film that is composed of a pair of resin layers, of which outer peripheries are heat-welded together, and that sandwich the electrode assembly;
wherein at least one separator of the electrode assembly has a protruding part that protrudes from the electrodes,
and is interposed at a peripheral area by a welded portion of the external sheathing film, and that restrains movement of the separators.

2. The battery according to claim 1,
wherein the protruding part restrains movement of the separators in both forward and backward direction of the protrusion.

3. The battery according to claim 1,
wherein the protruding part comprises:
a clamped part that restrains movement of the separator; and
a connecting part that connects the clamped part and a main body of the separator other than the protruding part.

4. The battery according to claim 3,
wherein the length of the clamped part in a direction that is substantially perpendicular to the direction of the protrusion is longer than the length of the connecting part in a direction that is substantially perpendicular to the direction of the protrusion.

5. The battery according to claim 1,
wherein the thickness of the protruding part is greater than or equal to 60 μm and less than or equal to 200 μm.

6. The battery according to claim 1,
wherein the separator is interposed by the welded portion of the external sheathing film over a width of greater than or equal to 2 mm at the peripheral area.

7. The battery according to claim 1,
further comprising lead parts connected to the electrode assembly and provided for connecting to the outside; and
of the external sheathing film, the width of the portion that is heat-welded along the side having the lead parts is greater than or equal to 5 mm.

8. The battery according to claim 1,
wherein the separator is selected from a separator containing aromatic polyamide resin or a ceramic-coated separator.
